(19) United States
(12) Patent Application Publication
(10) Pub. No.: US 2013/0287289 A1
(43) Pub. Date: Oct. 31, 2013

(54) Synthetic Reference Picture Generation

(71) Applicants: Dong Tian, Boxborough, MA (US); Danillo Bracco Graziosi, Somerville, MA (US); Anthony Vetro, Arlington, MA (US)

(72) Inventors: Dong Tian, Boxborough, MA (US); Danillo Bracco Graziosi, Somerville, MA (US); Anthony Vetro, Arlington, MA (US)

(21) Appl. No.: 13/455,904

(22) Filed: Apr. 25, 2012

(51) Int. Cl. G06K 9/36; G06K 9/00

(52) U.S. Cl. 382/154

(57) ABSTRACT

A synthetic image block in a synthetic picture is generated for a viewpoint based on a texture image and a depth image. A subset of samples from the texture image are warped to the synthetic image block. Disoccluded samples are marked, and the disoccluded samples in the synthetic image block are filled based on samples in a constrained area. The method and system enables both picture level and block level processing for synthetic reference picture generation. The method can be used for power limited devices, and can also refine the synthetic reference picture quality at a block level to achieve coding gains.

### FIELD OF THE INVENTION

This invention relates generally to 3D image and video coding, and more particularly to generating synthetic reference pictures.

### BACKGROUND OF THE INVENTION

Multiview video coding, which typically includes encoding and decoding in codecs, is essential for applications such as three dimensional television (3DTV), free viewpoint television (FTV), and multi-camera surveillance. Multiview video coding involves multiple texture and depth components, each corresponding to a different viewpoint of a scene.

There is significant redundancy between the different viewpoints of each texture component. Therefore inter-view prediction can be used to improve the compression efficiency of the codec.

In general, interview prediction is a process by which the texture from one viewpoint is predicted based on the texture from a different viewpoint. Disparity compensated prediction is a prior art technique wherein samples from one viewpoint are predicted from sample in a different viewpoint based on a disparity vector.

In conventional multiview image or video codec, the disparity vector is associated with a block in the picture to be coded.

View synthesis prediction (VSP) is another prior art technique for interview prediction. With VSP, depth values are used to synthesize a texture picture from a different viewpoint to the current viewpoint, such that the synthesized texture picture is a good predictor for the current picture. In the context of a video coding system, the synthesized picture is referred to as a synthesized reference picture. To enable such inter-view predictions, the depth information is encoded and transmitted together with the texture information to a decoder, see other U.S. applications by same Assignee, e.g., Ser. Nos. 11/292,167, 11/485,092, 11/621,400, and 13/299,195.

In conventional codecs, the process to generate the synthesized reference picture is defined at a picture level.

FIG. 1 shows such a decoder. Texture and depth images are accessed 110. The depth image is tested 120 to determine if it corresponds to the current viewpoint. If not, forward warping 121 is performed, and otherwise perform backward warping 122. In either case, the texture image is warped to the current viewpoint, and hole samples are marked and filled 130 with an in-painting process, and the synthesized picture is output 140.

However, it may be unnecessary to generate the entire synthesized reference picture because not all parts of the reference picture are referred to during the encoding and decoding process. As a result, memory and processing can be reduced.

A large disoccluded region of the synthesized reference picture can be present when the synthesized reference picture is generated from only one other viewpoint. Such disoccluded regions need be filled with the hole filling process.

Note, prior art hole filling methods do not use information in previously decoded and reconstructed blocks.

### SUMMARY OF THE INVENTION

The embodiments of the invention provide a method and codec for generating a synthetic reference picture, which is characterized by block level synthesis.

In one embodiment, a picture level synthesis procedure is implemented at a block level, while maintaining identical results by applying particular constraints. The selection of the implementation on the picture level or block level can be application specific.

In another embodiment, the synthetic reference picture is refined before coding the next block. For example, the previously synthesized blocks are replaced with the decoded block. Hole filling or refining is performed on a block by block basis.

In general, by referring to neighboring blocks that are already coded, the synthetic reference picture can be improved, and results in better prediction.

### BRIEF DESCRIPTION OF THE DRAWINGS

FIG. 1 is a flowchart of prior art process for synthetic reference picture generation;

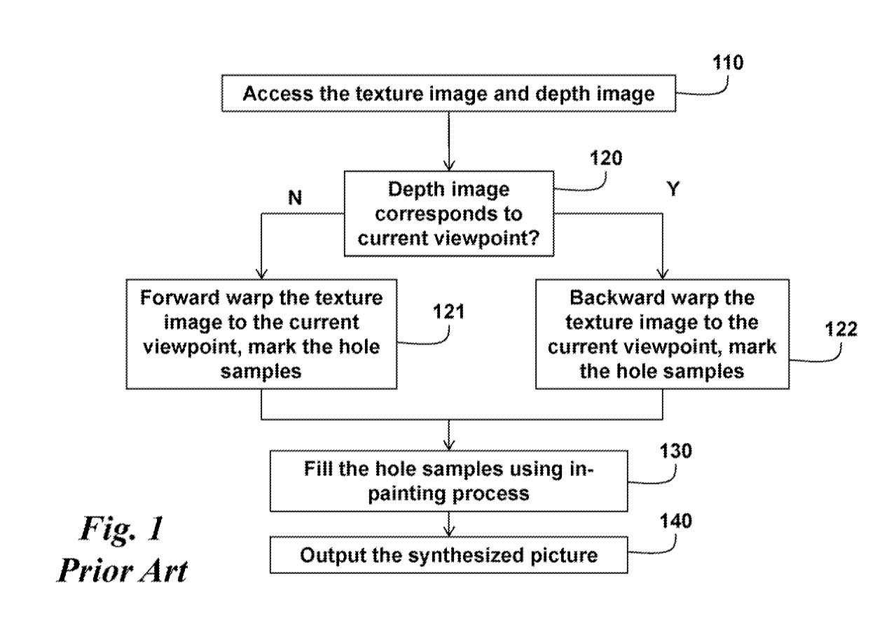

FIG. 2 is a flowchart of prior art process for forward warping with hole samples marked;

FIG. 3 is a flowchart of block-level forward synthesis and hole filling according to embodiments of the invention;

FIG. 4 is a flowchart to generate synthetic block with hole samples being marked using forward warping according to embodiments of the invention;

FIG. 5 is a flowchart of block-level backward synthesis and hole filling according to embodiments of the invention;

FIG. 6 is a flowchart to generate synthetic block with hole samples being marked using backward warping according to embodiments of the invention;

FIG. 7 is a flowchart of prior art process for hole filling in a block;

FIG. 8 is a schematic of an example of hole filling results using prior art method;

FIG. 9 is a flowchart of intra block hole filling according to embodiments of the invention;

FIG. 10 is a schematic of an example of hole filling results using intra block hole filling according to embodiments of the invention;

FIG. 11 is a flowchart of an encoder using a synthetic reference picture generated by a constrained method according to embodiments of the invention;

FIG. 12 is a flowchart of a decoder using a synthetic reference picture generated by a constrained method according to embodiment of the invention;

FIG. 13 is a schematic of a relationship between a block to be coded, a target synthetic reference block, and neighboring blocks of the target synthetic block according to embodiment of the invention;

FIG. 14 is a schematic of horizontal prediction to fill the hole samples in the target synthetic block according to embodiment of the invention;

FIG. 15 is a schematic of vertical prediction to fill the hole samples in the target synthetic block according to embodiment of the invention;

FIG. 16 is a schematic of diagonal prediction to fill the hole samples in the target synthetic block according to embodiment of the invention;

FIG. 17 is a schematic of inverse diagonal prediction to fill the hole samples in the target synthetic block according to embodiment of the invention;

FIG. 18 is a flowchart of a method to fill the hole samples in the target synthetic block when there are no hole samples along the boundary according to embodiment of the invention;

FIG. 19 is a flowchart of an Inter block hole filling method according to embodiment of the invention;

FIG. 20 is a flowchart of an encoder using constrained warping and Inter block hole filling according to embodiment of the invention;

FIG. 21 is a flowchart of a method to test a synthetic coding mode when constrained warping and Inter block hole filling is used according to embodiment of the invention;

FIG. 22 is a flowchart of a decoder using constrained warping and Inter block hole filling;

FIG. 23 is a flowchart of an encoder using a decoded block to update the synthetic reference picture according to embodiment of the invention;

FIG. 24 is a flowchart of a method to test a synthetic coding mode when synthetic reference picture is updated with a decoded block according to embodiment of the invention; and

FIG. 25 is a flowchart of a decoder using a decoded block to update the synthetic reference picture according to embodiment of the invention.

### DETAILED DESCRIPTION OF THE EMBODIMENTS OF THE INVENTION

Embodiments of the invention provide a method and codec for generating synthesized pictures, considering block-based processing constraints. In the following, block-based methods for forward warping, backward warping and hole filling are described.

As defined herein, coding can include encoding, decoding or both, and a codec can include an encoder, a decoder, or both. In most modern codecs, the output of the encoder is decoded and fed back to the encoder to compensate future encodings. The codec are typically implemented as integrated hardware circuits connected to memories and buffers. Hence, the functional blocks shown in the various figures are the means by which the circuits implement the steps to be performed by the circuits.

Forward Warping

Forward warping generates the synthetic reference picture when the depth map from the reference viewpoint is used to generate the synthetic picture. That is, the depth map from the reference viewpoint has been decoded (or encoded) prior to the decoding (or encoding) of the texture component for the current viewpoint.

For each sample Sᵣ at a location Xᵣ, in the reference picture, the depth, dᵣ, is known. The corresponding sample location in the current view, X_{c}, can be on a scene geometry, as given by camera parameters, such as focal length, f, baseline distance, l, nearest depth, Zₙₑₐᵣ, and farthest depth, Z_{far}.

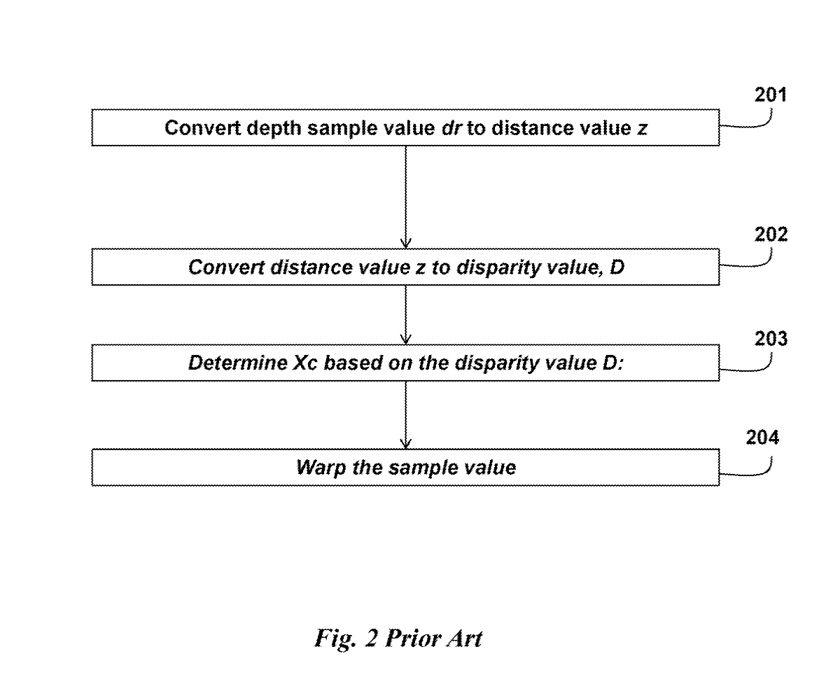

FIG. 2 shows the prior art forward warping process. Convert 201 depth sample value dᵣ to distance value z:

Z=1/((dᵣ/255)−(1/Zₙₑₐᵣ−1/Z_{far})+1/Z_{far})

Convert 202 distance value z to disparity value, D:

D=(f·l)/z

Determine 203 X_{c} based on the disparity value D:

X_{c}=Xᵣ+D.

Warp 204 the sample value:

S_{c}(X_{c})=Sᵣ(Xᵣ).

Conflicts can arise during the forward warping when a sample in the synthetic view is mapped multiple times. When such conflicts occur, the warping, which is associated with a larger disparity by being closer to the camera, is used.

Conventionally, the above warping process is performed in a loop over all the samples in the reference view and the forward warping is performed at the picture level. After all samples in the reference view are warped, there can be some samples in the synthetic picture, which have no mapped values, and are marked as hole samples.

To enable forward warping, the maximum disparity Dₘₐₓ is calculated for the whole picture as

Dₘₐₓ=(f·l)/Zₙₑₐᵣ.

A block B_{c} in synthetic picture to be warped is denoted by its top-left and bottom-right locations (Xₜₗ, Yₜₗ) and (X_{br}, Y_{br}). A block in the reference picture Bᵣ is determined by applying the maximum disparity Dₘₐₓ, which is denoted as (Xₜₗ−Dₘₐₓ, Yₜₗ) and (X_{br}+Dₘₐₓ, Y_{br}). A hole sample mask for block B_{c} is also initialized. Note that the defined block in the reference picture Bᵣ, (Xₜₗ−Dₘₐₓ, Yₜₗ)˜(X_{br}+Dₘₐₓ, Y_{br}) is based on the assumption that the multiview pictures are rectified. In a more general case, Bᵣ can be specified by also giving the maximum vertical disparity D_{max, vertical}: (Xₜₗ−Dₘₐₓ, Yₜₗ−D_{max, vertical})˜(X_{br}+Dₘₐₓ, Y_{br}+D_{max, vertical}). Without sacrificing the generality, the multiview pictures are assumed having been recitiefied in the following descriptions.

In the block-level forward synthesis according to embodiments of the invention, the loop of warping is conducted on the sample blocks in the synthetic picture instead of the loop over the samples in the reference texture picture as in the prior art.

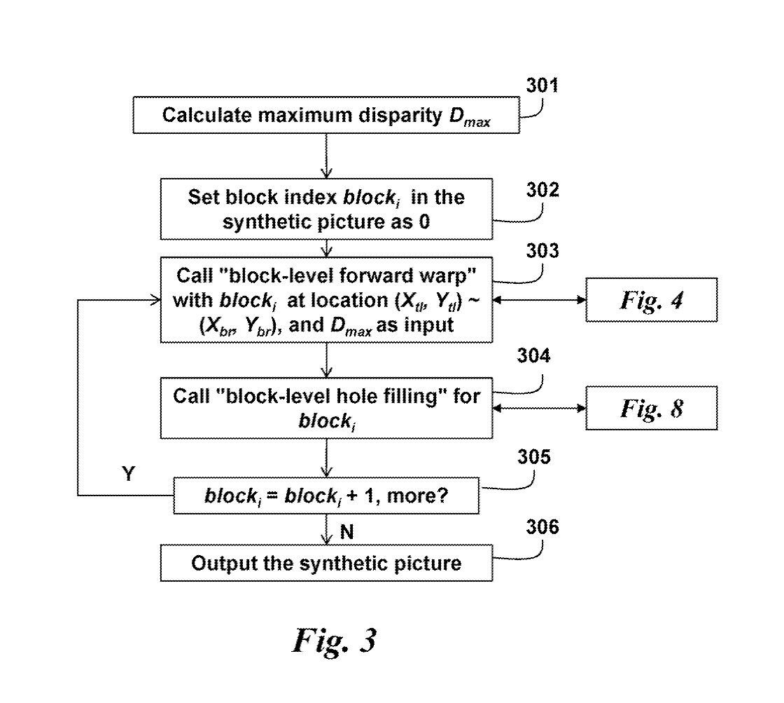

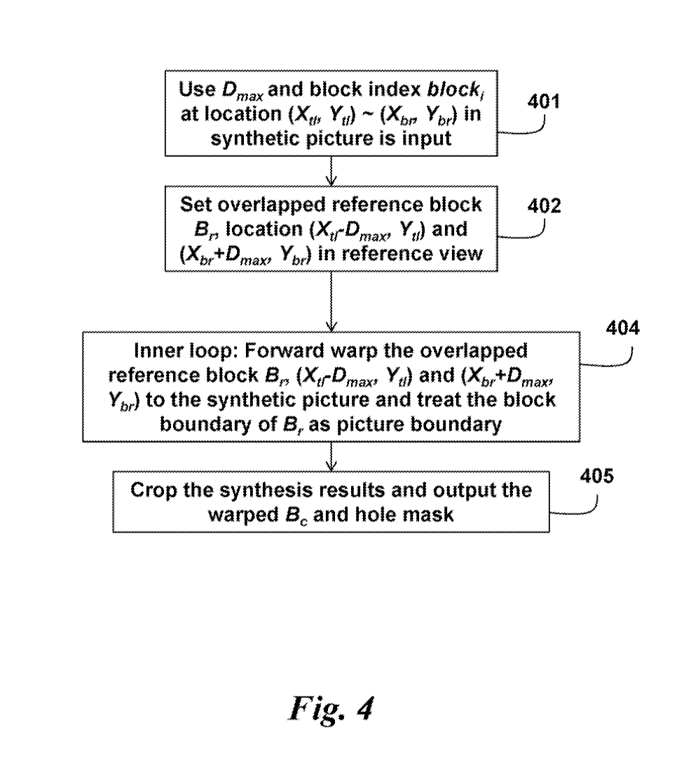

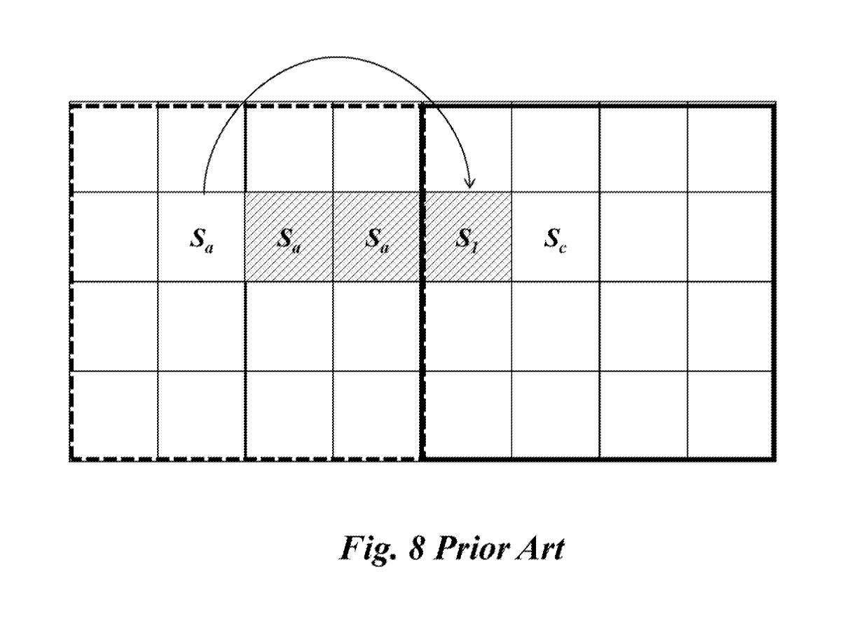

FIG. 3 shows a loop over all blocks in the synthetic picture, which calls “block-level forward warp” (FIG. 4), and “block-level hole filling” FIG. 8.

Calculate 301 the maximum disparity. Set 302 block index i in reference picture to 0. Call 303 block-level forward warp. Call 304 block-level hole filling. Increment 305 block index i, loop if more, and otherwise output 306 synthetic picture.

In the loop, all samples within block Bᵣ are forward mapped to the synthetic reference picture. The mappings that falls outside B_{c} are cropped.

FIG. 4 elaborates the inner loop module “block-level forward warp.” Use 401, depth and indexed block in synthetic picture as input. Set 402 overlapped reference block locations in reference view. Forward warp 404 in inner loop, and crop 405 results before outputting warped block and hole mask.

With our forward warping, the computational complexity at the decoder can be reduced because only those blocks that refer to the synthetic reference picture are mapped. However, encoder complexity can be increased because the different blocks (Bᵣ) can overlap each other. In any case, the hole samples need be filled. Several hole filling methods are described for the embodiments below.

Backward Warping

In this embodiment, it is assumed that the depth map from the current viewpoint is used generate the synthetic picture. That is, the depth map from the current viewpoint has already been decoded (or encoded) prior to the decoding (or encoding) of the texture component from the current viewpoint. For each sample S_{c}, at a location, X_{c} in the synthetic picture, the depth, d_{c}, is known. The corresponding sample location in the reference view Xᵣ can be determined based on the scene geometry as described above.

The prior art backward warping process is described by the following steps.

Step 1. Convert depth sample value d to distance value z:

Z=1/((d_{c}/255)−(1/Zₙₑₐᵣ−1/Z_{far})+1/Z_{far}).

Step 2. Convert distance value z to disparity value, D:

D=(f·l)/z.

Step 3. Determine Xᵣ based on the disparity value D:

Xᵣ=X_{c}−D.

Conflicts can occur during the backward warping when a sample in the reference view is mapped multiple times. When such conflicts occur, the warping, which is associated with a larger disparity is used, and the samples that were not warped are marked as hole samples.

Conventionally, the above warping and hole marking process can be conducted at picture level.

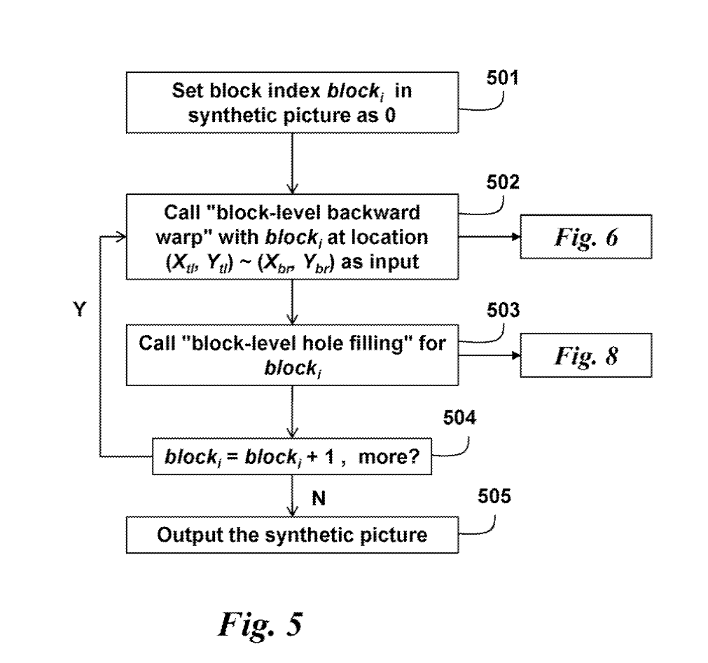

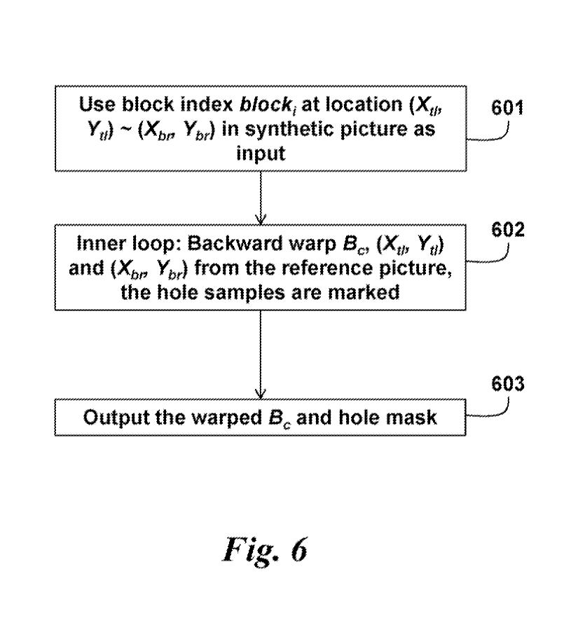

We use a procedure that operates at the block level as shown in FIG. 5 and FIG. 6.

FIG. 5 shows the loop over the synthetic block to do block-level backward warping and hole filling. This process is very similar to the forward napping of FIG. 3. Set 501 block index. Call 502 block-level backward warp. Call 503 block-level hole filing. Increment 504 block index, and output 505 synthetic picture.

FIG. 6 shows the details of an inner loop to do backward warping of a synthetic block with hole samples being marked, in a similar manner as described for FIG. 4. Use 601 indexed block. Backward warp 602 in inner loop, and output 602 warped block and hole mask.

Hole Filling

In the prior art, in-painting methods are typically used to fill the hole samples by making use of the warped samples around the hole samples. For instance, the background sample can be propagated into the hole area.

However, such prior art methods do not consider any block level constraint on the processing. For example, to fill a big hole, a sample that is farther away from a hole sample can be used as a reference for hole filling. That is, the hole filling result of a block is affected by the warping and hole filling results from a sample far away, and hence the hole filling results of a block can be different if a sample far away was not synthesized at all.

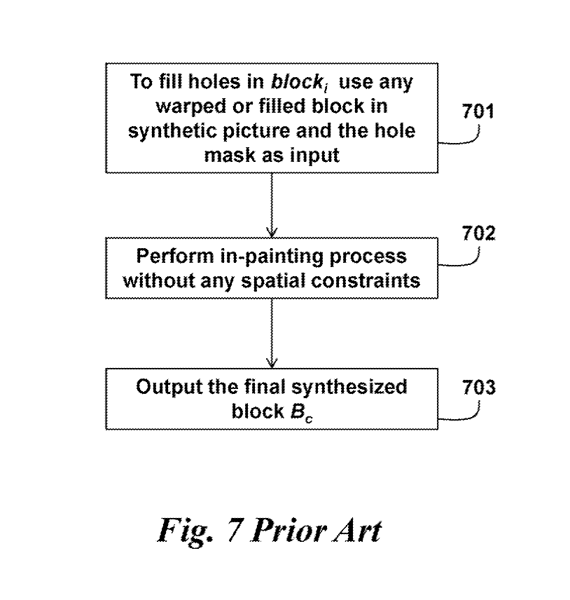

FIG. 7 shows prior art hole filling. To fill holes, use any warped or filled block in synthetic picture and hole mask as input 701, perform 702 in-painting process without any spatial constraints, and output 703 the final synthesized block.

In any of the following Figs. showing block level hole filling, holes samples are shown hatched.

As shown in FIG. 8, consider an example, the 1^{st} samples S₁ of the first row in the block is a hole, the 2^{nd} sample of the first row has a warped value S_{c}, and its associated depth is D_{c}. On the other hand, the first non-hole pixel to the left in the same row has a sample value Sₐ, and its associated depth is Dₐ, which is smaller than D_{c}. With the prior art hole filling, sample S₁ is to be set equal to Sₐ. Furthermore, the samples from the decoded blocks are never referred for hole filling because the prior art hole filling is performed before picture decoding or encoding.

To facilitate the block level synthesis, we describe several hole filling methods with constraints.

Intra Block Hole Filling

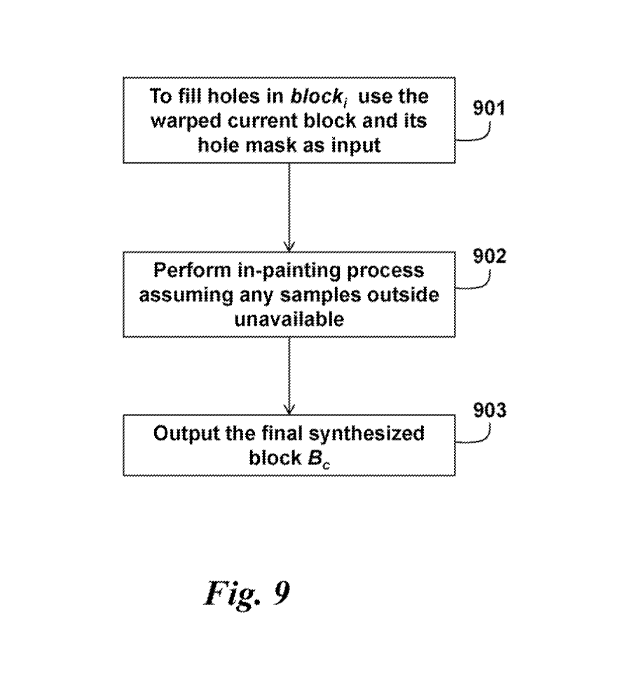

In one embodiment for Intra block hole filling as shown in FIG. 9, we perform hole filling within a block. That is, the samples outside of a block B_{c} are not used by the hole filling process. To fill holes, we use 901 only the current warped block, perform 902 in-painting, and output 903 the block.

With the constraint in this embodiment, each block can be filled independently from other blocks. Though the synthetic quality is not optimal, a parallel implementation can be used.

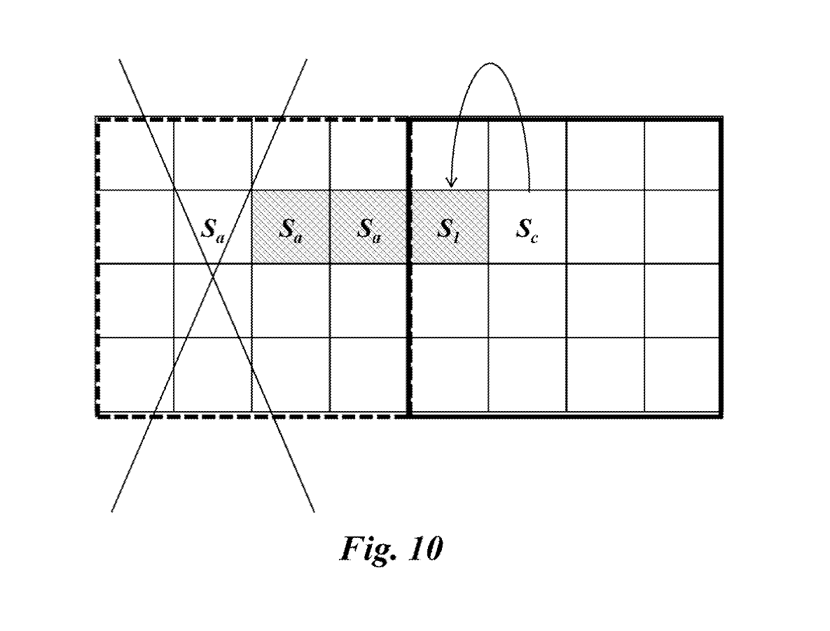

For the same example of FIG. 8, FIG. 10 shows sample S₁ is to be set equal to S_{c}, instead of Sₐ with intra block hole filling as in the prior art.

Encoder/Decoder Using Intra Block Hole Filling

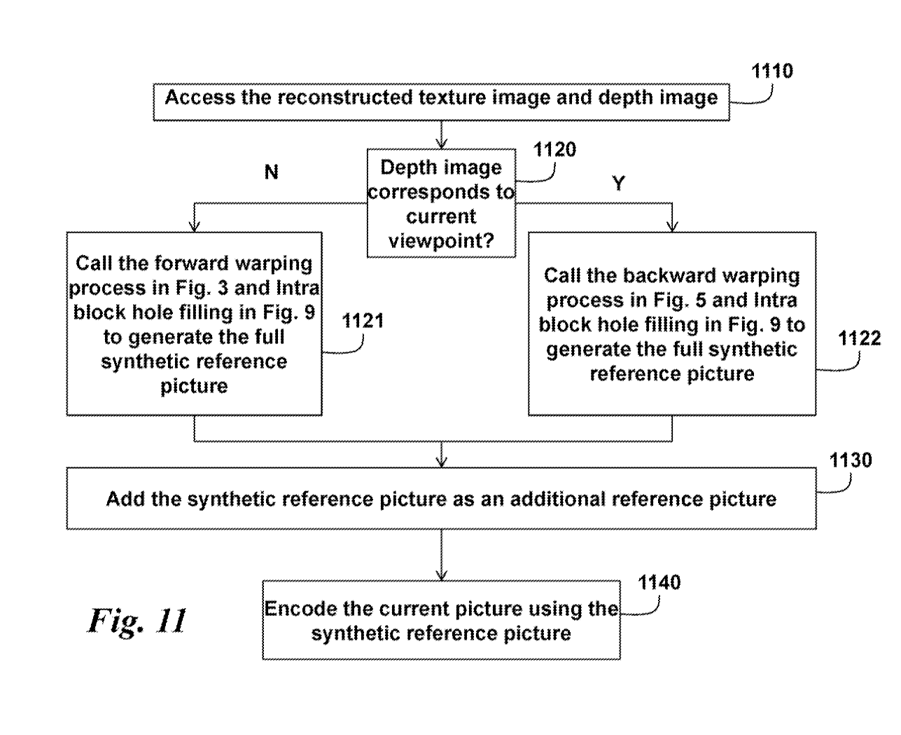

FIG. 11 shows an encoder that implements the constrained forward (or backward) warping and Intra block hole filling according to embodiments of the invention. A texture and depth images are accessed 1110. The depth image is tested 1120 to determine if it corresponds to the current viewpoint. If not, forward warping 1121 is performed, and otherwise perform backward warping 1122. In either case, the texture image is warped to the current viewpoint, and hole samples are marked and filled (1121, 1122) with an in-painting process. The synthetic picture is then added 1130 to the reference picture buffer, such that it can be used to encode 1140 the current picture.

This encoder uses the forward warping and Intra hole filling process shown in FIG. 3 (or the backward warping and Intra hole filling process as shown in FIG. 5), and generates the full synthetic reference picture. After the full synthetic reference picture is generated, it is added into the reference picture list. The full synthetic reference picture is generated because the encoder needs to evaluate whether the synthetic picture is a best predictor comparing to temporal/spatial predictors. Thus, there is no complexity reduction in terms of synthetic reference picture generation at the encoder.

However, it is unnecessary for this decoder to generate the full synthetic reference picture. Only the synthetic blocks that contain samples, which are used as reference need to be synthesized.

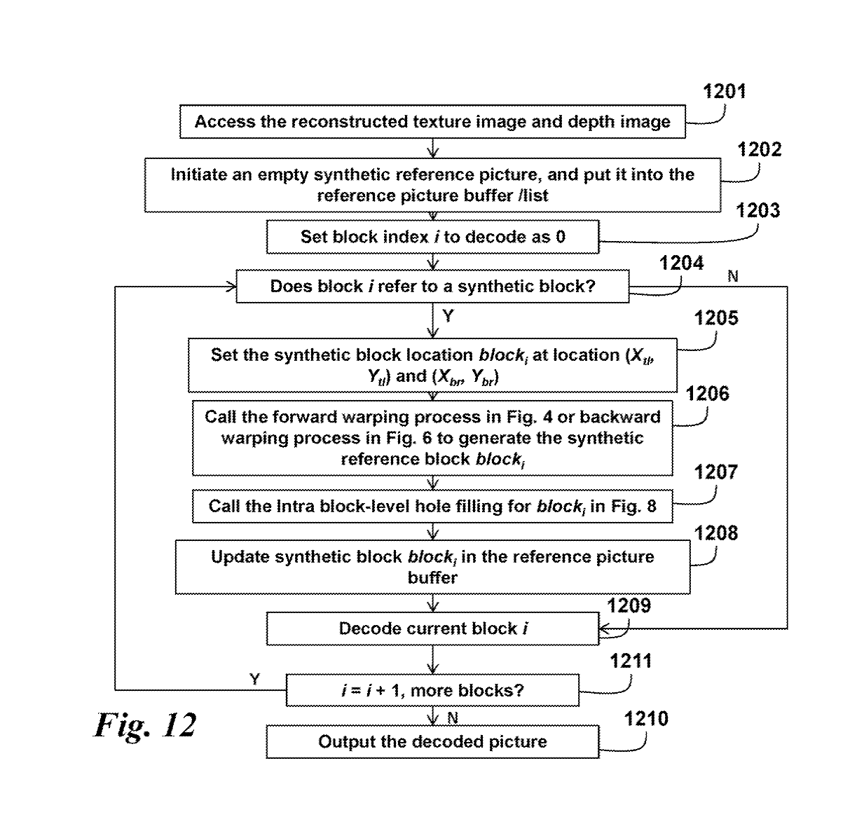

FIG. 12 shows a decoder that implements the constrained forward (or backward) warping and Intra block hole filling. It is possible to reduce complexity in the decoder. Access 1201 the texture and depth images as before. Initiate 1202 an empty synthetic reference picture, and put it into the reference picture buffer list. Set 1203 block index i to be decoded as 0. Does block i refer to a synthetic block 1204? If no, decode 1209 the current block directly. If yes, set 1205 the synthetic block block; that are referred at location (Xₜₗ, Yₜₗ) and (X_{br}, Y_{br}). Perform forward/backward warping br, 1206, intra block hole filling 1207, update 1208 synthetic block block; in the reference picture buffer, and finally decode 1209 block. Test 1211 if there are more blocks to decode, if yes, loop. Otherwise, if not, output 1210 decoded picture.

Inter Block Hole Filling

In the previous embodiment, a neighbor block is not synthesized at the decoder if it is not used as a reference. However, a neighbor block can have been decoded before decoding the current block. In this embodiment, we use any surrounding block of a synthetic reference block that has already been decoded as a predictor to fill the hole samples in the synthetic reference block.

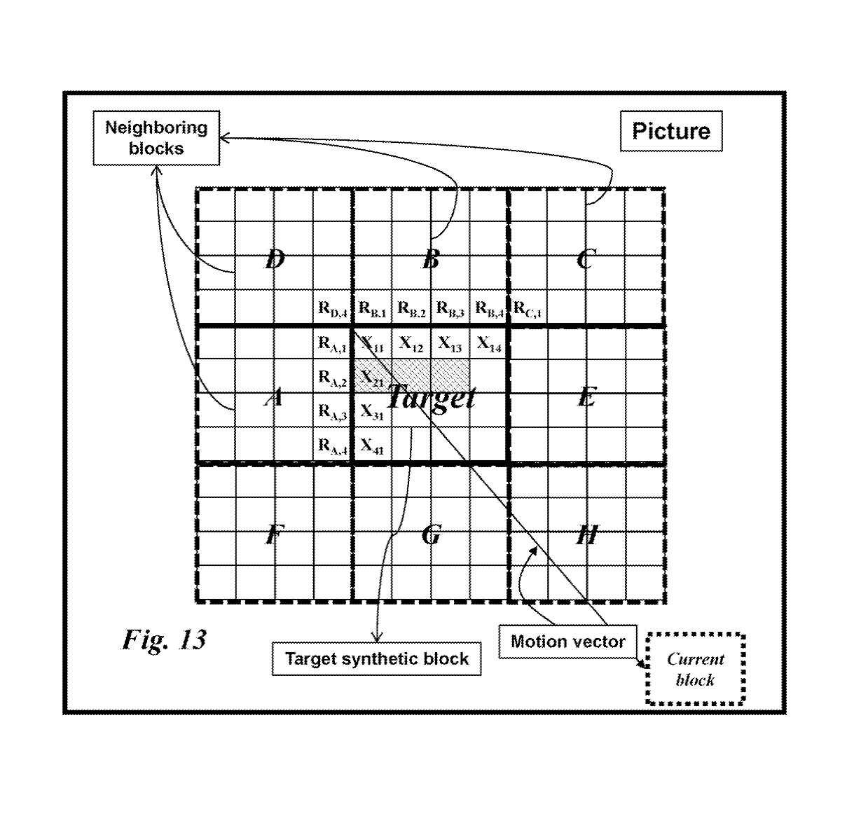

In FIG. 13, the motion vector for the current block to be coded point to a target synthetic reference block. All the eight blocks (A through H) surrounding the target block are candidate predictors to fill the hole samples in the target block. Herein, and in subsequent similar schematics, the target block includes 4×4 samples need be filled with values. The sample values from the neighbor blocks, X_{i,j}, and the reference blocks include reverence values R_{i, j} may be used as reference to fill hole samples in the current block.

Without sacrificing generality of the invention, we describe this embodiment assuming four neighbors from left and top available for the target block (block A, B, C and D). Note that the neighbor blocks refer to the decoded blocks instead of previously synthesized blocks.

This method improves coding performance as it is possible to generate a better synthetic block for prediction. We describe the following procedure according to this invention to fill the hole samples in the target synthetic block.

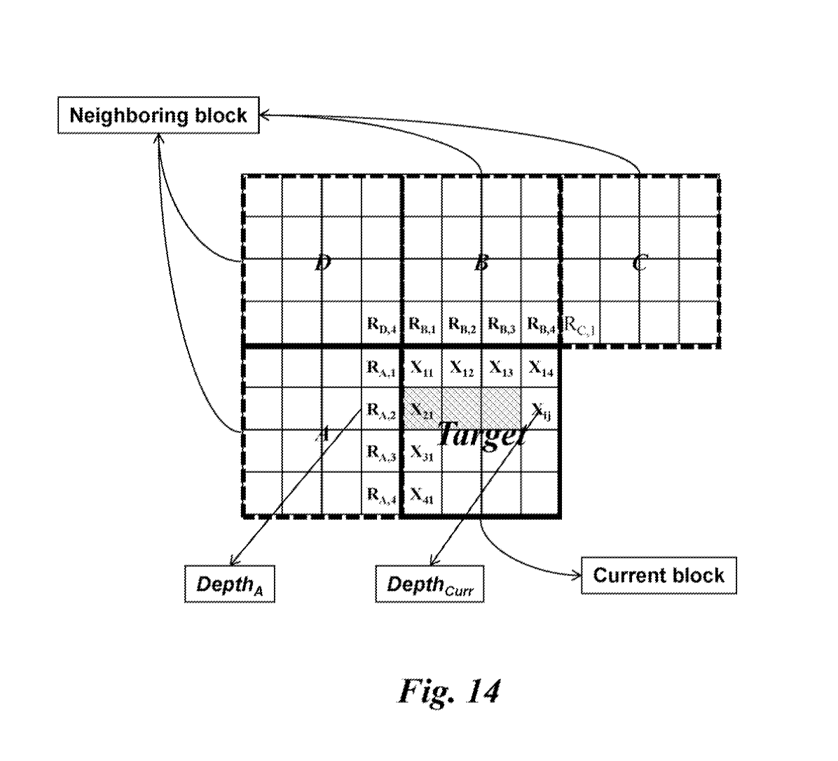

In one embodiment of the invention as shown in FIG. 14, a horizontal prediction from neighbor block A on the left is always used as a potential value to fill the hole. If the entire row of the block is a hole, use sample R_{A, i} (from left block) to fill the entire row of the block. For a row in the current block that has a hole sample at Xᵢₗ, let Depth_{A} denote the depth of R_{A,i} and Depth_{Curr} denote the depth of the first non-hole sample Xᵢⱼ from the left in the target block. If Depth_{A} is less than Depth_{Curr}, use sample R_{A,i} to fill the holes; otherwise, use sample Xᵢⱼ to fill the holes.

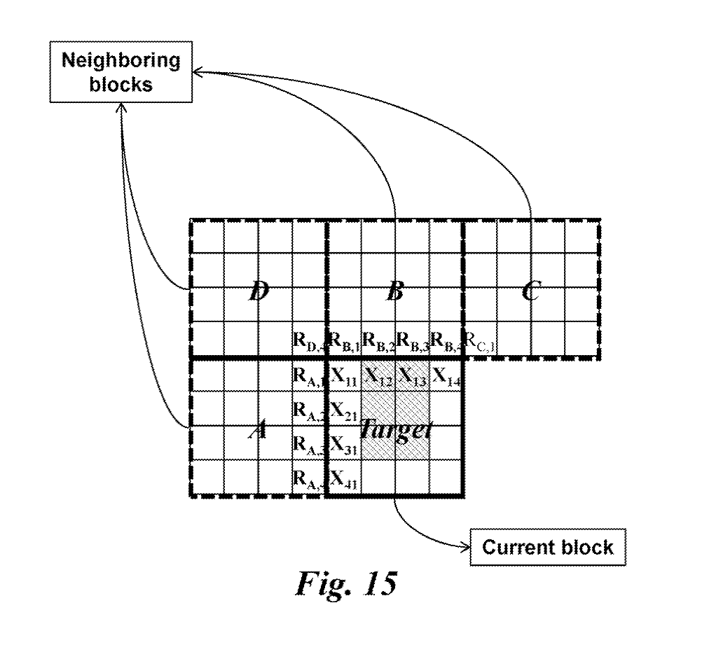

In another embodiment as shown in FIG. 15, we first classify a block by inspecting the hole locations, and can apply a prediction method other than horizontal prediction, such as vertical prediction, diagonal prediction and inverse diagonal prediction. When the hole appears as a vertical wedge, the sample values R_{B,i} from the block B are used to fill the hole samples. In FIG. 15, R_{B, 2} and R_{B, 3} are used to fill the hole samples.

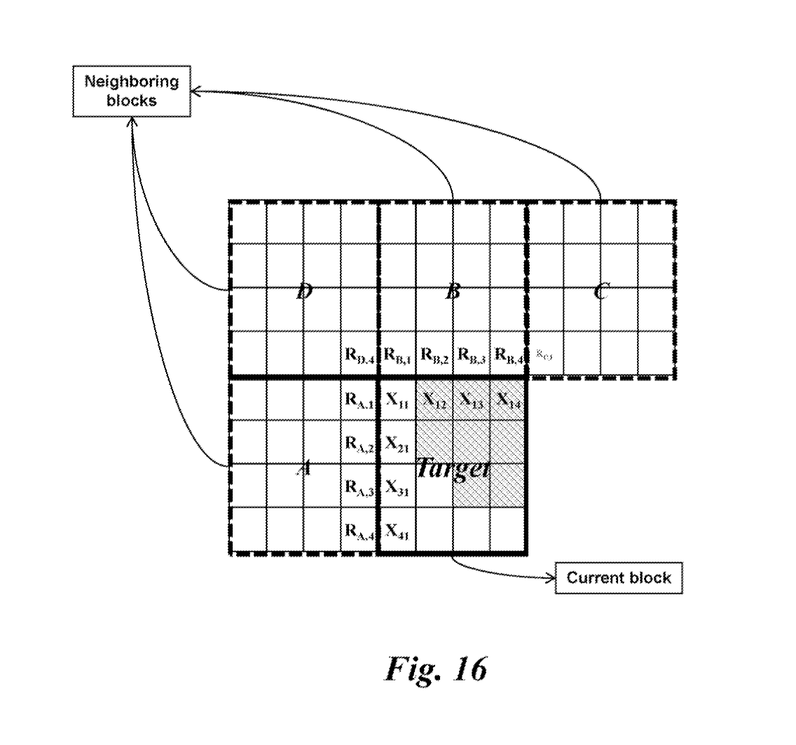

When most of the hole samples appear in the top right part of the block as shown in FIG. 16, the sample value of R_{C, 1} from the block C is used to fill the hole samples in the block.

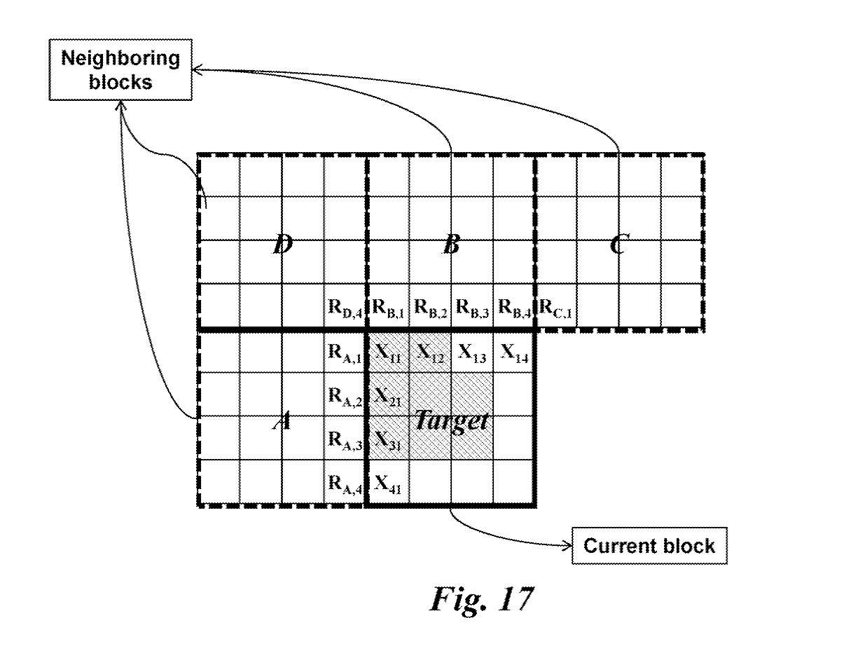

When most of the hole samples appear in the top left part of the block, the sample value of R_{D,4} from the block D is used to fill the hole samples in the block, see FIG. 17.

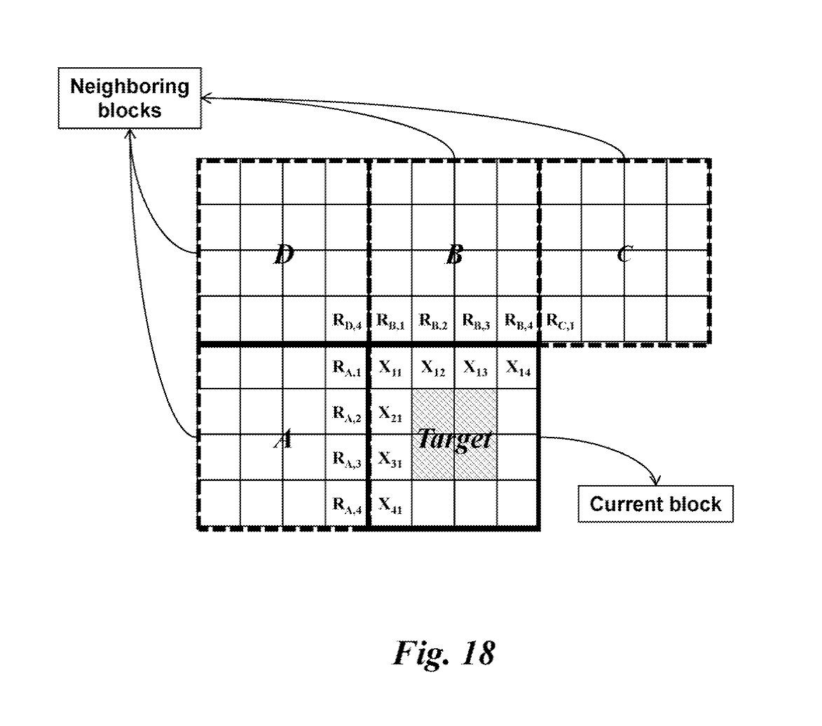

If no prediction from neighbors are available, or if there are no hole samples along the boundary of the current block (FIG. 18), all hole samples in the current block are filled using any existing prior art in-painting method, e.g., using a surrounding sample associated with a smaller depth value (background sample), or just a predefined sample value.

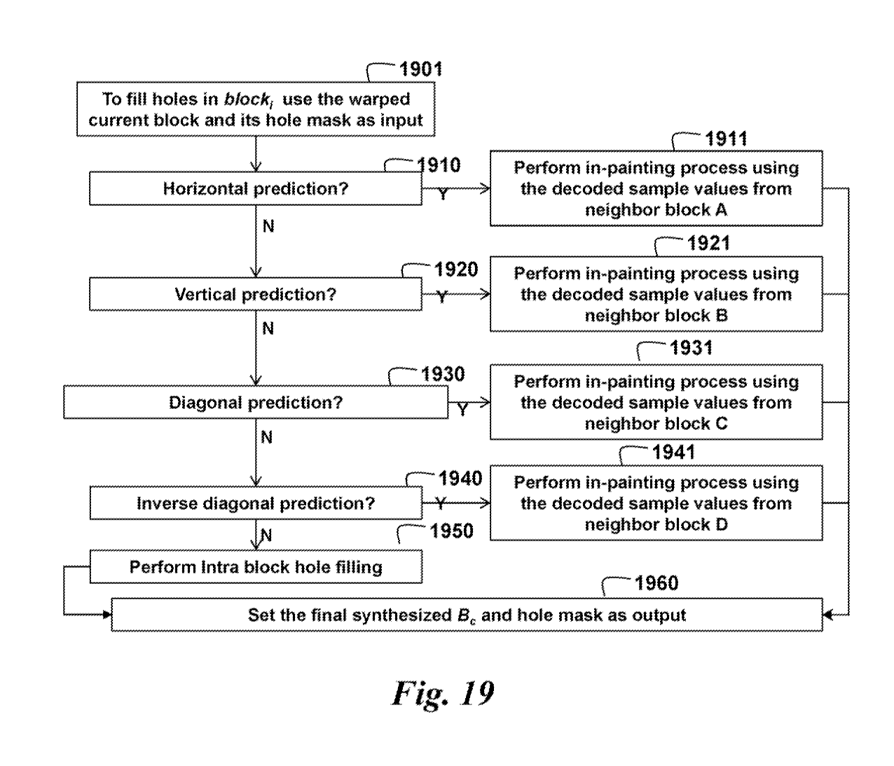

FIG. 19 shows Inter block hole filling using the five different prediction methods described above in our codec. To fill holes in a block use 1901 the warped current block and its hole mask as input. For horizontal prediction 1910, perform 1911 in-painting process using the decoded sample values from neighbor block A. For vertical prediction 1920, perform 1921 in-painting process using the decoded sample values from neighbor block B. For diagonal prediction 1930, perform 1931 in-painting process using the decoded sample values from neighbor block C. For inverse diagonal prediction 1940, perform 1941 in-painting process using the decoded sample values from neighbor block D. Otherwise, perform 1950 Intra block hole filling. Set 1960 the final synthesized B_{c} and hole mask as output.

Encoder/Decoder using Inter Block Hole Filling

In one embodiment, we use Inter block hole filling to improve the hole filling quality of a synthetic block.

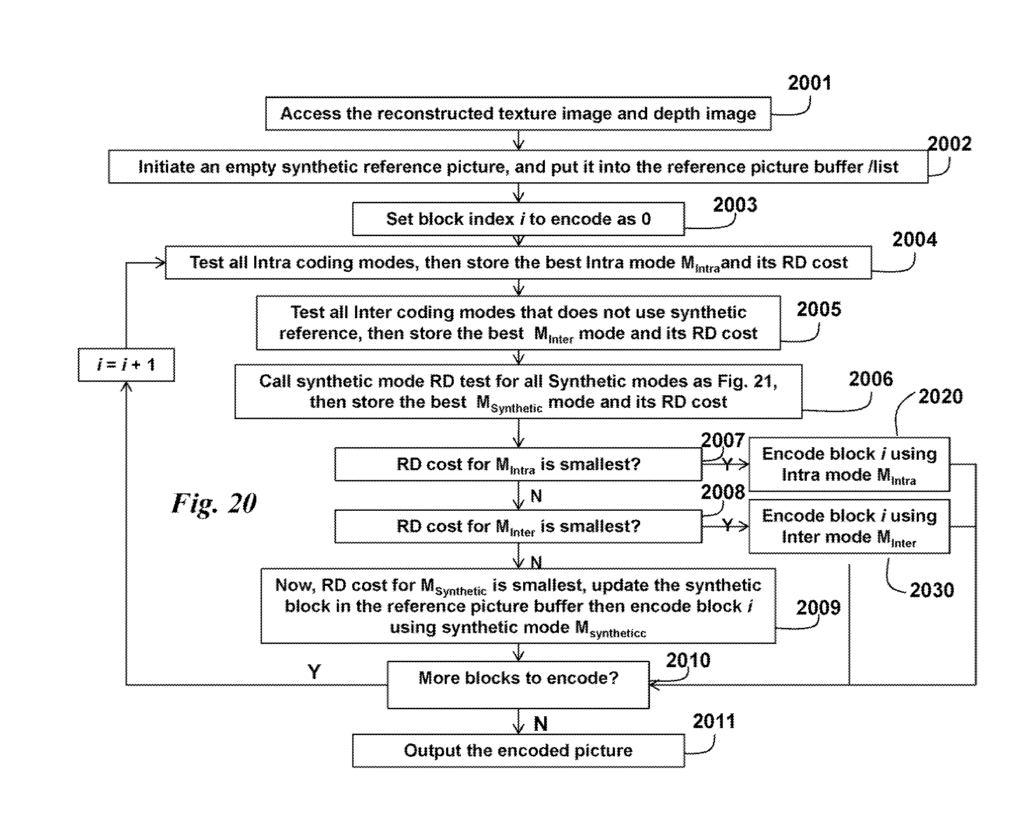

FIG. 20 shows the process of an encoder design. At the beginning of encoding a picture, an empty synthetic reference picture is inserted to the reference picture buffer/list. Then the encoder performs rate distortion (RD) test on all possible coding modes. The coding modes are classified into three types. Intra modes, Inter modes (any inter mode without referring to the synthetic reference picture), and Synthetic modes (any inter mode referring to the synthetic reference picture). The encoder selects the coding mode producing the least RD cost.

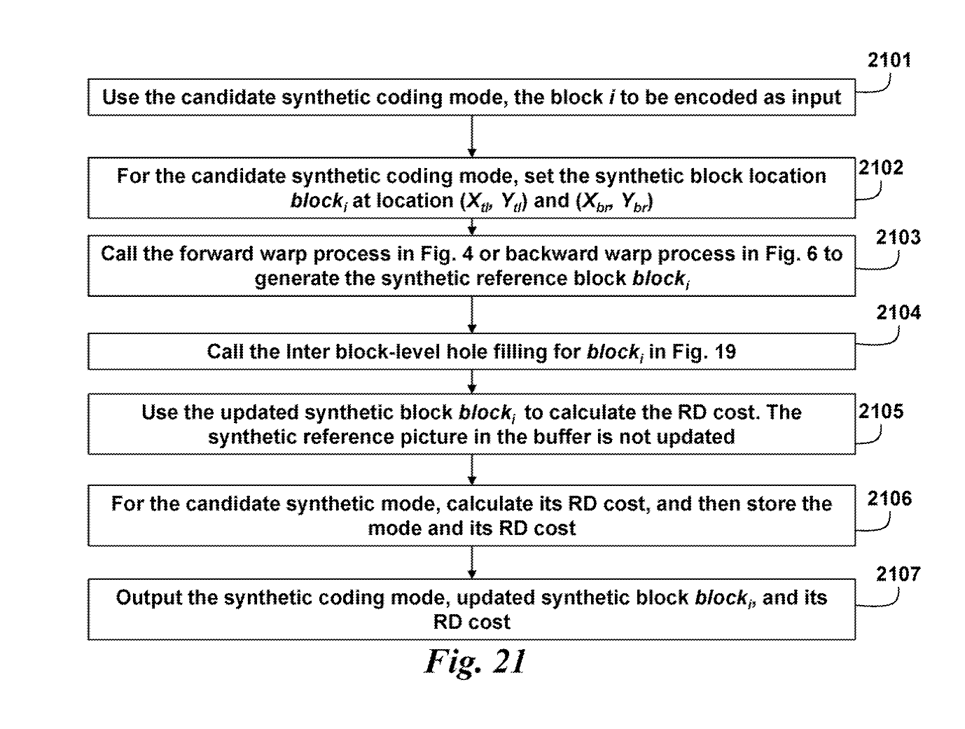

In detail, the steps are as follows. Access 2001 the reconstructed texture image and depth image. Initiate 2002 an empty synthetic reference picture, and put it into the reference picture buffer/list. Set 1203 block index i to encode as 0. Test 2004 all Intra coding modes, then store the best intra mode N_{Intra} and its RD cost. Test. 2005 all inter coding modes that do not use synthetic reference, then store the best M_{Inter} mode and its RD cost. Call 2006 synthetic mode RD test for all Synthetic modes as FIG. 21, then store the best M_{Synthetic} mode and its RD cost. Is 2007 RD cost for M_{Intra} is smallest? If yes, encode 2020 the block with M_{Intra} mode. If no, is 2008 RD cost for M_{Inter} the smallest? If yes, encode the block with M_{Inter} mode. If no, now, RD cost for M_{synthetic} is smallest, update 2009 the synthetic block in the reference picture buffer then encode block i using synthetic mode M_{syntheticc}. More blocks to encode 2010? If no, output 2011 the encoded picture. otherwise iterate.

The process of testing synthetic modes is further shown in FIG. 21. For each synthetic coding mode, the encoder identifies the location of the synthetic reference block. For the synthetic block, the forward warp or backward warp is conducted, and then the Inter block hole filling is applied. The generated synthetic block is used to calculate the distortion and RD cost to encode the current block. Note that the generated synthetic block is not updating the reference picture buffer while testing a candidate synthetic mode unless the Synthetic mode is finally being selected. In detail, the steps are as follows.

Use 2101 the candidate synthetic coding mode, the block i to be encoded as input. For the candidate synthetic coding mode, set 2101 the synthetic block location block I at location (Xₜₗ, Yₜₗ) and (X_{br}, Y_{br}) Call 2103 the forward warp process in FIG. 4 or backward warp process in FIG. 6 to generate the synthetic reference block, blockᵢ. Call 2104 the Inter block-level hole filling for blockᵢ in FIG. 19. Use 2105 the updated synthetic block, blockᵢ, to calculate the RD cost. Note the synthetic reference picture in the buffer is not updated in this process. For the candidate synthetic mode, calculate 2106 its RD cost, and then store the mode and its RD cost. Output 2107 the synthetic coding mode, updated synthetic block, blockᵢ, and its RD cost.

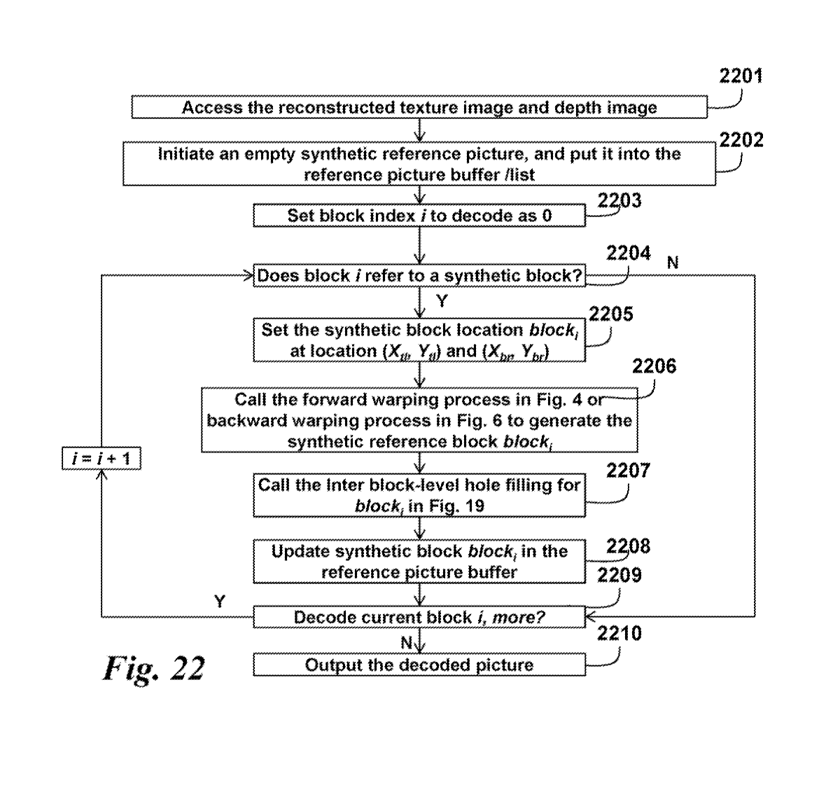

FIG. 22 shows the decoder that calls the Inter block hole filling. Note that the only difference from FIG. 12 is the hole filling method being called. Inter block hole filling is possible to improve the quality of the synthetic reference block, when comparing to Intra block hole filling. In detail, the steps are as follows.

Access 2201 the reconstructed texture image and depth image. Initiate 2202 an empty synthetic reference picture, and put it into the reference picture buffer/list. Set 2203 block index i to be decoded as 0. Does block i refer to a synthetic block 2204? If no, decode 2209 the current block directly. If yes, set 2205 the synthetic block blockᵢ that is referred at location (Xₜₗ, Yₜₗ) and (X_{br}, Y_{br}). Perform 2206 forward/backward warping, inter block hole filling 2207, update 2208 synthetic block blockᵢ in the reference picture buffer, and finally decode 2209 block. Test 2209 if there are more blocks to decode, if yes, loop. Otherwise, if not, output 2210 decoded picture.

Synthetic Reference Picture Refinement

In another embodiment, we can use the decoded (or encoded) block to update the synthetic reference picture. As the decoded block is likely of higher quality than the synthesized block, replacing a previously synthesized block with the decoded block provides benefits in coding the following blocks in the picture.

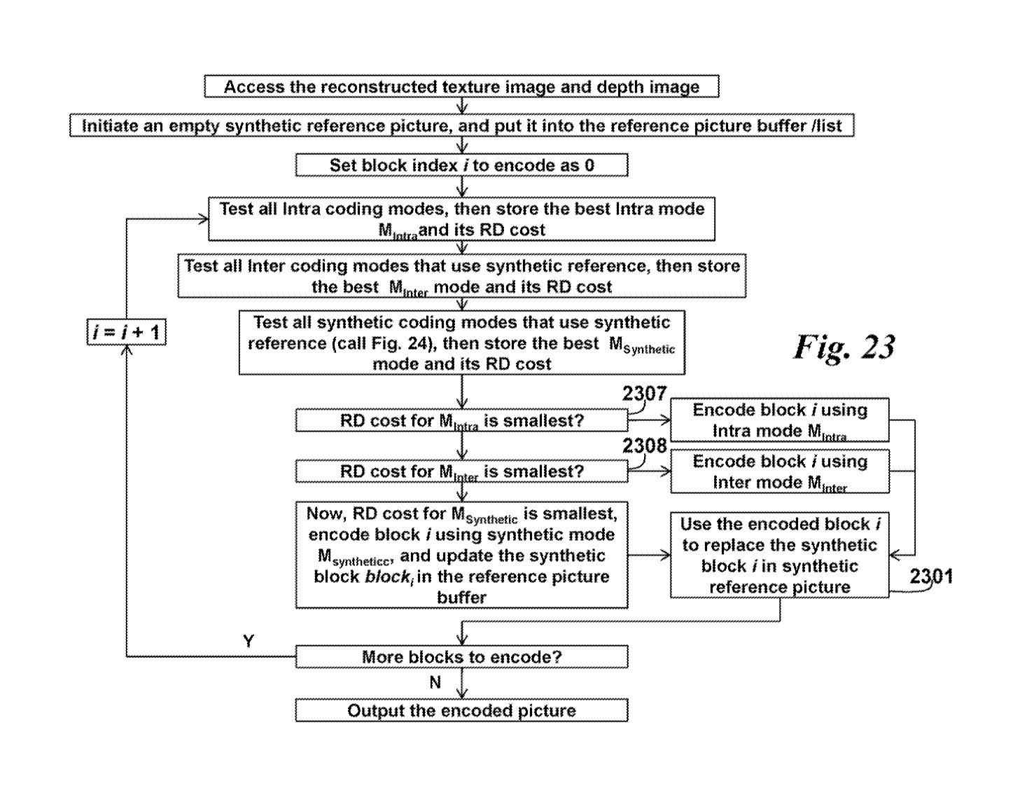

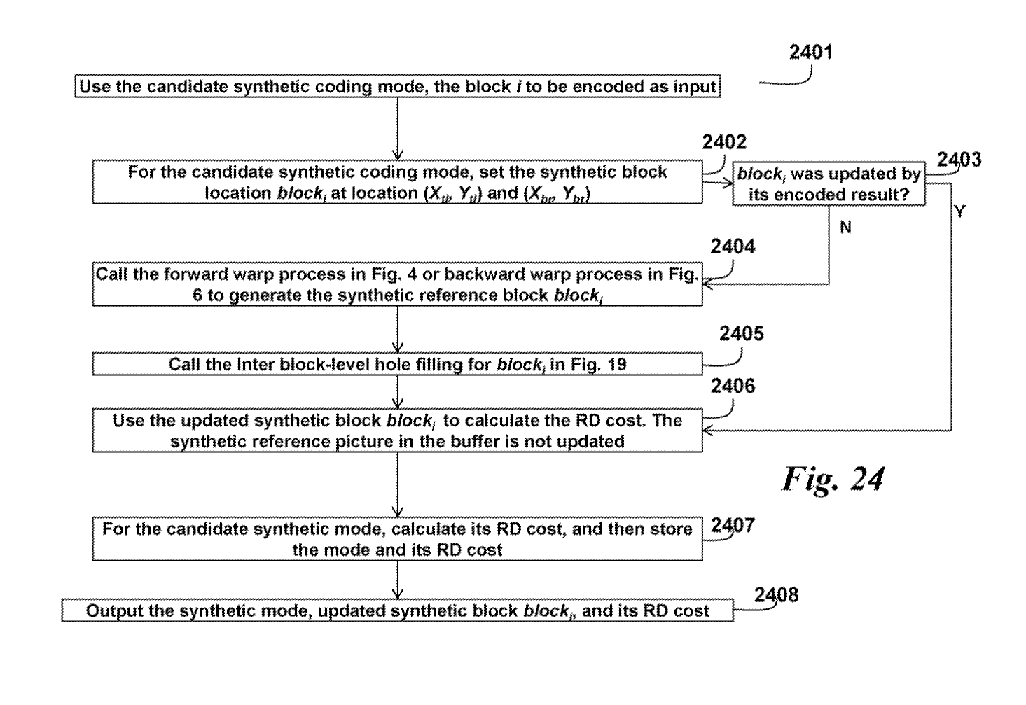

FIG. 23 shows encoder. This is similar to that described for FIG. 20. Compared to FIG. 20, there are two differences: a) A new module 2301 is added, “Use the encoded block i to replace the synthetic block i in synthetic reference picture” after a block is encoded. b) The RD test process 2307-2308 is modified and further depicted in FIG. 24. If a synthetic block being referred was actually updated by its encoded result, the synthesis step and hole filling step are skipped, as compared to FIG. 21.

In details, Use 2401 the candidate synthetic coding mode, the block i to be encoded as input. For the candidate synthetic coding mode, set 2402 the synthetic block location block i at location (Xₜₗ, Yₜₗ) and (X_{br}, Y_{br}) block i was updated by its encoded result? If yes, got to step 2406. Otherwise, call 2404 the forward warp process in FIG. 4 or backward warp process in FIG. 6 to generate the synthetic reference block, blockᵢ. Call 2405 the Inter block-level hole filling for blockᵢ in FIG. 19. Use 2406 the updated synthetic block, blockᵢ, to calculate the RD cost. Note the synthetic reference picture in the buffer is not updated in the process. For the candidate synthetic mode, calculate 2407 its RD cost, and then store the mode and its RD cost. Output 2408 the synthetic mode, updated synthetic block, blockᵢ, and its RD cost.

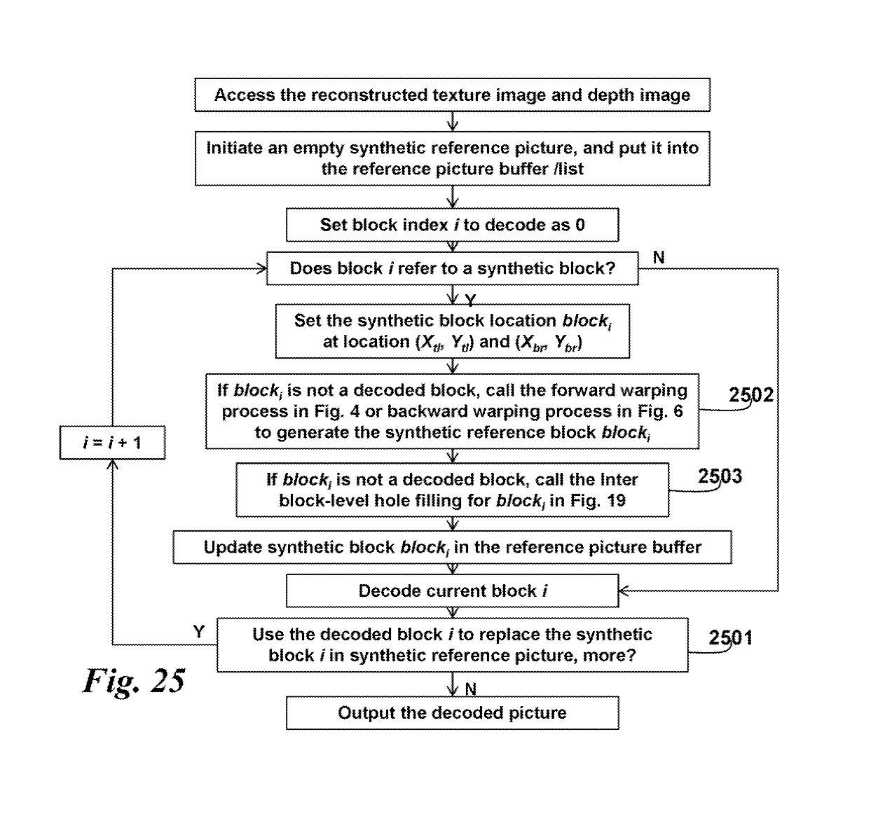

FIG. 25 shows the decoder, which is similar to that shown in FIG. 22. Compared to FIG. 22, the difference is that a new module 2501 is added, “Use the encoded block i to replace the synthetic block i in synthetic reference picture,” and two modified modules 2502, 2503, the block level synthesis 2502 and hole filling 2503 are only called if the synthetic block was not updated by a decoded block.

Note, the synthetic picture refinement is a block level process, but it may or may not be combined with block level synthesis.

### Effect of the Invention

With the enhanced synthesis method to generate the synthetic reference picture in a 3D video coding system as described herein, it is possible to reduce the decoder computation complexity and/or to improve the coding efficiency.

We claim:

1. A method for generating a synthetic image block in a synthetic picture for a viewpoint based on a texture image and a depth image, comprising the steps of:
warping a subset of samples from the texture image to the synthetic image block;
marking disoccluded samples; and
filling the disoccluded samples in the synthetic image block based on samples in a constrained area, wherein the steps are performed in a codec.

2. The method of claim 1, wherein the depth image corresponds to a viewpoint, and forward warping is performed.

3. The method of claim 1, wherein the depth image corresponds to the viewpoint to be decoded, and backward warping is performed.

4. The method of claim 2, wherein a subset of samples in the texture image is an overlapped image block, further comprising:
determining a maximum disparity Dₘₐₓ;
accessing a location of a current block to be decoded, denoted by a top-left and bottom-right location (Xₜₗ, Yₜₗ) and (X_{br}, Y_{br});
determining a location of an overlapped block in a reference texture image by applying the maximum disparity Dₘₐₓ, which is (Xₜₗ−Dₘₐₓ, Yₜₗ, and (X_{br}+Dₘₐₓ, Y_{br}).

5. The method of claim 1, wherein the constrained area for hole filling is the same as a warped block for intra block hole filling.

6. The method of claim 5, wherein the constrained area further comprises the neighboring blocks that are decoded in a current picture being decoded for inter block hole filling.

7. The method of claim 6, further comprising:
performing horizontal prediction from a neighboring block on the left in decoded picture to fill the hole samples.

8. The method of claim 6, further comprising:
performing vertical prediction from a neighboring block on the top in a decoded picture to fill the hole samples.

9. The method of claim 6, further comprising:
performing diagonal prediction from a neighboring block on the top right in a decoded picture to fill the hole samples.

10. The method of claim 6, further comprising:
performing inverse diagonal prediction from a neighboring block on the top left in a decoded picture to fill the hole samples.

11. The method of claim 5, further comprising:
replacing a synthetic block in a synthetic reference picture with a corresponding decoded block to refining the synthetic reference picture.

12. The method of claim 11, further comprising:
performing horizontal prediction from a neighboring block on the left in the synthetic picture to fill the hole samples.

13. The method of claim 11, further comprising:
performing vertical prediction from a neighboring block on the top in the synthetic picture to fill the hole samples.

14. The method of claim 11, further comprising:
performing diagonal prediction from a neighboring block on the top right in the synthetic picture to fill the hole samples.

15. The method of claim 11, further comprising:
performing inverse diagonal prediction from a neighboring block on the top left in the synthetic picture to fill the hole samples.

16. The method of claim 2, wherein a subset of samples in the texture image is an overlapped image block, further comprising:
determining a horizontal maximum disparity Dₘₐₓ, and a vertical maximum disparity D_{max, vertical};
accessing a location of a current block to be decoded, wherein the location is denoted by a top-left and bottom-right location (Xₜₗ, Yₜₗ) and (X_{br}, Y_{br}); and
determining a location of an overlapped block in a reference texture image by applying the maximum disparity Dₘₐₓ, which is (Xₜₗ−Dₘₐₓ, Yₜₗ+D_{max, vertical}) and (X_{br}+Dₘₐₓ, Y_{br}+D_{max, vertical}).

17. A codec for generating a synthetic image block in a synthetic picture for a viewpoint based on a texture image and a depth image, comprising:
means for warping a subset of samples from the texture image to the synthetic image block;
means for marking disoccluded samples; and
means filling the disoccluded samples in the synthetic image block based on samples in a constrained area, wherein the steps are performed in a coder.

18. A codec using synthetic blocks in a synthetic picture for a viewpoint, comprising:
means for updating a first synthetic block in the synthetic picture with a reconstructed block;
means for updating hole filling for a second synthetic block in the synthetic picture by referencing the first synthetic block; and
means for using the synthetic picture with the updated first and second synthetic blocks as a reference picture to code a next block, wherein the blocks are based on a texture image and a depth image.
